(19) United States
(12) Patent Application Publication
(10) Pub. No.: US 2024/0362583 A1
(43) Pub. Date: Oct. 31, 2024

(54) PRIORITIZING INVENTORY CHECK AND ADUITS FOR A MULTI-PRODUCT RETAILER

(71) Applicant: Google LLC, Mountain View, CA (US)

(72) Inventors: Ramesh Natarajan, Mountain View, CA (US); Wangyang Zhang, Allison Park, PA (US); Julian Everett Robinson, Mountain View, CA (US)

(73) Assignee: Google LLC, Mountain View, CA (US)

(21) Appl. No.: 18/307,084

(22) Filed: Apr. 26, 2023

(51) Int. Cl. G06Q 10/087

(52) U.S. Cl. CPC G06Q 10/087

(57) ABSTRACT

A method for prioritizing inventory checks and audits includes receiving a plurality of product identifiers. Each respective product identifier of the plurality of product identifiers is associated with a respective product of a plurality of products. For each respective product identifier of the plurality of product identifiers, the method also includes predicting, using an inventory predictor model, a mixture probability distribution over possible quantities for the associated respective product, and generating, using the mixture probability distribution, a respective inventory confidence score. Here, the respective inventory confidence score indicates a confidence estimation of an actual inventory of the respective associated product. The method further includes selecting, using each respective inventory confidence score for each respective product, a list of candidate products from the plurality of products, the list of candidate products ordering the candidate products based on an uncertainty of the actual inventory of the respective candidate product.

### TECHNICAL FIELD

This disclosure relates to a method for prioritizing inventory checks and audits for a multi-product retailer.

### BACKGROUND

In multi-product retail stores, inventory checks and audits are a manual and labor-intensive process that generally requires a store associate to identify the physical location of a product in the retail store inventory and manually count the number of products available. While these types of inventory checks and audits incur additional time and labor costs, poor inventory accuracy leads to potential lost sales, excess on-hand inventory, and suboptimal replenishment orders. Accordingly, multi-product retail stores may implement an annual audit, as well as perform unscheduled audits of a selection of products to verify the accuracy of the product inventory at any given time. However, multi-product retail stores may carry thousands or tens of thousands of different products, such that unscheduled audits may not accurately direct labor resources to products or product areas that have the greatest business impact.

### SUMMARY

One aspect of the disclosure provides a computer-implemented method that when executed on data processing hardware causes the data processing hardware to perform operations that include receiving a plurality of product identifiers. Each respective product identifier of the plurality of product identifiers is associated with a respective product of a plurality of products. For each respective product identifier of the plurality of product identifiers, the operations also include predicting, using an inventory predictor model, a mixture probability distribution over possible quantities for the associated respective product, and generating, using the mixture probability distribution, a respective inventory confidence score. Here, the respective inventory confidence score indicates a confidence estimation of an actual inventory of the respective associated product. The operations further include selecting, using each respective inventory confidence score for each respective product, a list of candidate products from the plurality of products. The list of candidate products orders the candidate products based on an uncertainty of the actual inventory of the respective candidate product.

Implementations of the disclosure may include one or more of the following optional features. In some implementations, the operations further include generating an audit notification including the list of candidate products. In some examples, selecting the list of candidate products includes selecting a threshold quantity of respective products from the plurality of products with the lowest inventory confidence score. In some implementations, the respective inventory confidence score of each respective candidate product of the list of candidate products satisfies a maximum confidence threshold.

In some examples, the operations further determining that the respective inventory confidence score of a particular respective candidate product of the list of candidate products satisfies a minimum confidence threshold, and, in response to determining that the respective inventory confidence score of a particular respective candidate product of the list of candidate products satisfies the minimum confidence threshold, triggering a restock event of the particular respective candidate product. In some implementations selecting the list of candidate products from the plurality of products includes ordering each respective candidate product of the list of candidate products from the respective candidate product having the lowest inventory confidence score to the respective candidate product having the highest inventory confidence score. In some examples, the mixture probability distribution over possible quantities for the product includes a probability of one or more of zero inventory, correct inventory, or a long-tail distribution. In these examples, the long-tail distribution may include one of a gamma distribution or a t-distribution.

In some implementations, the operations further include ranking the list of candidate products based on one or more of a sales volume of each respective candidate product, an inventory estimate of each respective candidate product, an audit history of each respective candidate product, or a product category of each respective candidate product. In some examples, the operations further include receiving training data including a plurality of product features paired with audit correction labels, and training the inventory predictor model on the plurality of product features. In these examples, the plurality of product features includes one or more of an inventory history, a sales history, a replenishment history, an audit history, a product ID, a product category, a product description, an inventory store ID, a store type, or a store zip code.

Another aspect of the disclosure provides a system including data processing hardware and memory hardware in communication with the data processing hardware. The memory hardware stores instructions that when executed by the data processing hardware cause the data processing hardware to perform operations that include receiving a plurality of product identifiers. Each respective product identifier of the plurality of product identifiers is associated with a respective product of a plurality of products. For each respective product identifier of the plurality of product identifiers, the operations also include predicting, using an inventory predictor model, a mixture probability distribution over possible quantities for the associated respective product, and generating, using the mixture probability distribution, a respective inventory confidence score. Here, the respective inventory confidence score indicates a confidence estimation of an actual inventory of the respective associated product. The operations further include selecting, using each respective inventory confidence score for each respective product, a list of candidate products from the plurality of products. The list of candidate products orders the candidate products based on an uncertainty of the actual inventory of the respective candidate product.

This aspect may include one or more of the following optional features. In some implementations, the operations further include generating an audit notification including the list of candidate products. In some examples, selecting the list of candidate products includes selecting a threshold quantity of respective products from the plurality of products with the lowest inventory confidence score. In some implementations, the respective inventory confidence score of each respective candidate product of the list of candidate products satisfies a maximum confidence threshold.

In some examples, the operations further determining that the respective inventory confidence score of a particular respective candidate product of the list of candidate products satisfies a minimum confidence threshold, and, in response to determining that the respective inventory confidence score of a particular respective candidate product of the list of candidate products satisfies the minimum confidence threshold, triggering a restock event of the particular respective candidate product. In some implementations selecting the list of candidate products from the plurality of products includes ordering each respective candidate product of the list of candidate products from the respective candidate product having the lowest inventory confidence score to the respective candidate product having the highest inventory confidence score. In some examples, the mixture probability distribution over possible quantities for the product includes a probability of one or more of zero inventory, correct inventory, or a long-tail distribution. In these examples, the long-tail distribution may include one of a gamma distribution or a t-distribution.

In some implementations, the operations further include ranking the list of candidate products based on one or more of a sales volume of each respective candidate product, an inventory estimate of each respective candidate product, an audit history of each respective candidate product, or a product category of each respective candidate product. In some examples, the operations further include receiving training data including a plurality of product features paired with audit correction labels, and training the inventory predictor model on the plurality of product features. In these examples, the plurality of product features includes one or more of an inventory history, a sales history, a replenishment history, an audit history, a product ID, a product category, a product description, an inventory store ID, a store type, or a store zip code.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example for prioritizing inventory checks and audits for a multi-product retailer using an inventory predictor model.

FIG. 2 is a schematic view of example components of the system of FIG. 1.

FIG. 3 is a schematic view of an example training process for training an inventory predictor model to learn consistent predictions on products in inventory.

FIG. 4 is a flowchart of an example arrangement of operations for a method of prioritizing inventory checks and audits for a multi-product retailer using an inventory predictor model.

FIG. 5 is a schematic view of an example computing device that may be used to implement the systems and methods described herein.

Like reference symbols in the various drawings indicate like elements.

### DETAILED DESCRIPTION

In multi-product retail stores, inventory checks and audits are a manual and labor-intensive process that generally requires a store associate to identify the physical location of a product in the retail store inventory, and manually count the number of products available. While these types of inventory checks and audits incur additional time and labor costs, poor inventory accuracy leads to potential lost sales, excess on-hand inventory, and suboptimal replenishment orders. Accordingly, multi-product retail stores may implement an annual audit, as well as perform unscheduled audits of a selection of products to verify the accuracy of the product inventory at any given time. However, multi-product retail stores may carry thousands or tens of thousands of different products, such that unscheduled audits may not accurately direct labor resources to products or product areas that have the greatest business impact.

Implementations herein include an inventory audit prioritizer that uses a predictive model to predict a mixture probability distribution of the certainty of a product inventory and ranks the products in terms of uncertainty that may be balanced with relevant business impacts. The ranked products may provide a prioritized list of products for a sales associate performing inventory checks and audits. For example, the prioritized list allows a multi-product retailer to prioritize its labor resources towards auditing products where the business impact (e.g., based on the retailers' business needs) is the greatest (e.g., prioritize audits for products with the greatest inventory uncertainty).

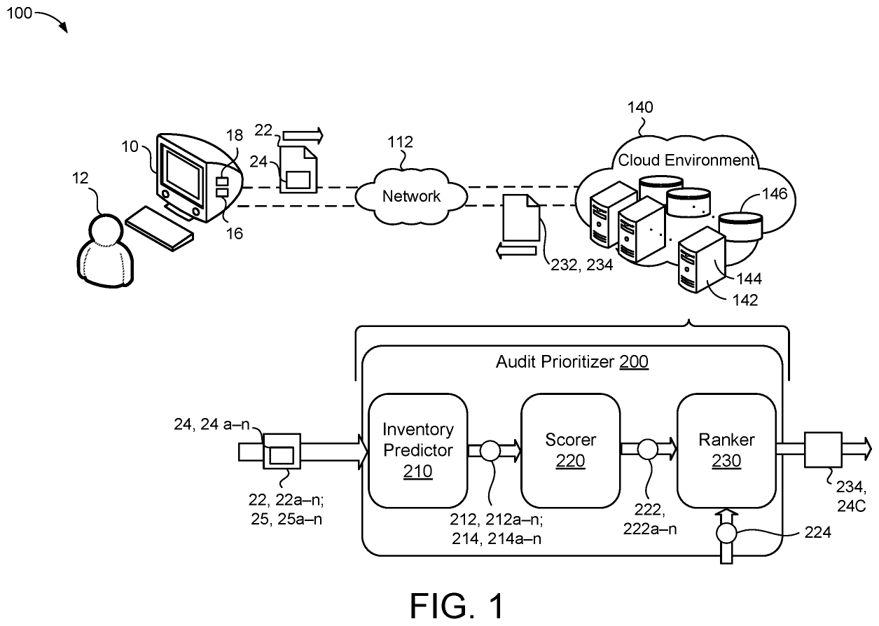

Referring to FIG. 1, in some implementations, an example system 100 includes a user device 10 associated with a respective user 12 (e.g., a sales associate of a retail store) in communication with a remote system 140 via a network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). The remote system 140 may be a single computer, multiple computers, or a distributed system (e.g., a cloud environment) having scalable/elastic computing resources 144 (e.g., data processing hardware) and/or storage resources 142 (e.g., memory hardware). Data stores 146, 146a-n (i.e., a remote storage device 146) may be overlain on the storage resources 142 to allow scalable use of the storage resources 142 by one or more of the client or computing resources 144.

The remote system 140 executes an inventory audit prioritizer 200 implementing an inventory predictor model 210 (also referred to as the model 210) and receives a plurality of product identifiers 22, 22a-n, each product identifier 22 associated with a product 24 in a plurality of products 24a-n (e.g., products 24 stocked by a store or other business). The inventory predictor model 210 is a neural network trained under machine or human supervision to receive product features 25, 25a-n for a respective product 24 as input and generate, as output, a mixture probability distributions 214 over possible quantities 212 for the respective product 24. For example, the inventory predictor model 210 is a regression model trained with a mean absolute error (MAE) loss function.

The product features 25 may be stored in the data store 146 of the storage resources 142, where the inventory predictor model 210 automatically retrieves/accesses the product features 24 based on receiving the product identifier 22. In other implementations, the user 12 provides the product features 25 for each of the product identifiers 22. The product features 25 may include one or more of an inventory history, a sales history, a replenishment history, an audit history, a product ID, a product category, a product description, an inventory store ID, a store type, or a store zip code. In addition to the product features 25, the product identifiers 22 and the associated products 24 may be stored in the data store 146 of the storage resources 142.

The remote system 140 is configured to receive the plurality of product identifiers 22 from, for example, the user device 10 via the network 112, although the remote system 140 may receive the product identifiers 22 from other entities (e.g., a remote server). Using the product identifiers 22, the audit prioritizer 200 may select products 24 to generate a list of candidate products 24C to determine a priority for products 24 that may undergo an inventory audit. Put another way, the list of candidate products 24C orders the products 24 based on an uncertainty of the actual inventory of the respective product 24.

The audit prioritizer 200 receives each of the product identifier 22 (e.g., from the user device 10 and/or remote system 140), and, using the inventory predictor model 210, predicts, for example, a mixture probability distribution 214, 214a-n over possible quantities 212, 212a-n for the product 22. That is, the inventory predictor model 210 receives the plurality of product identifiers 22 and, for each product 24 associated with a product identifier 22 in the plurality of product identifiers 22, generates/predicts the mixture probability distribution 214 over possible quantities 212 (i.e., ranges of quantities) for the product 24. As will be discussed in more detail below, for each product 24, a scorer model 220 of the audit prioritizer 200 generates, using the quantity 212 and the mixture probability distribution 214, an inventory confidence score 222, 222a-n (i.e., a confidence estimation) of an actual inventory of the product 24. Here, the inventory confidence score 222 indicates a certainty (or alternatively, an uncertainty) that the mixture probability distribution 214 over possible quantities 212 accurately corresponds to the actual inventory of the product 24. Additionally, a ranker model 230 of the audit prioritizer 200 selects the list of candidate products 24C based on the plurality of confidence scores 222 determined for the plurality of products 24. The list of candidate products 24C may be ordered based on the uncertainty of the actual inventory of the respective candidate product 24C (e.g., the list of candidate products 24C may be ordered from most uncertain to least uncertain or vice versa). Thereafter, the audit prioritizer 200 may generate an audit notification 234 including the list of candidate products 24C from the plurality of products 24, where the audit notification 234 is provided to the user 12 (e.g., a sales associate 12) to conduct an inventory check and audit on some or all of the candidate products 24C in the list of candidate products 24C where the sales associate prioritizes auditing candidate products 24C that have a greater uncertainty of the actual inventory of the respective candidate product 24C. In some implementations, the results of the subsequent audit performed by the sales associate are fed back into the inventory predictor model 210 to fine tune the inventory predictor model 210.

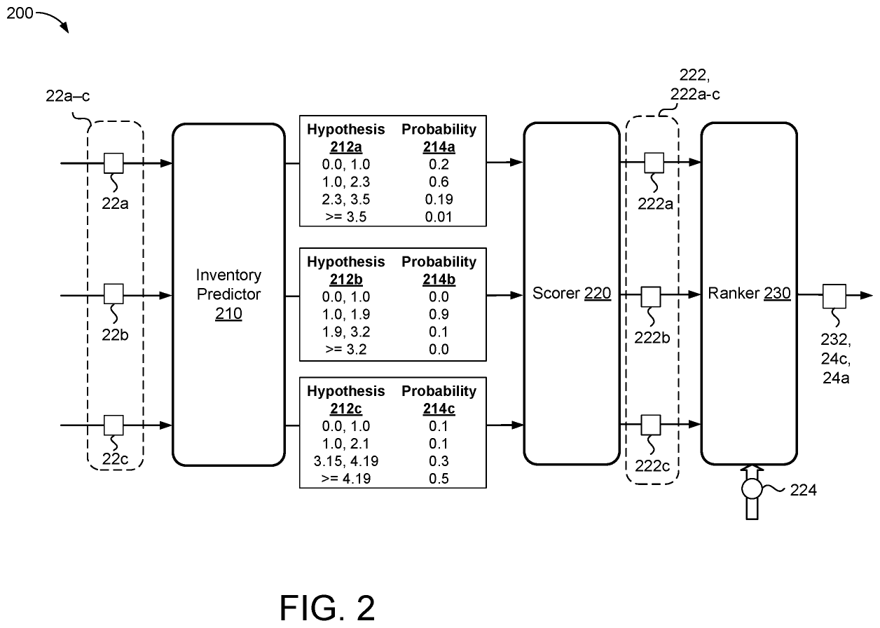

Referring now to FIG. 2, a schematic view of the audit prioritizer 200 exemplifies prioritizing inventory checks and audits of a plurality of products 24 based on a certainty of a mixture probability distribution 214 over possible quantities 212 for each of the products 24. A shown, the audit prioritizer 200 includes the inventory predictor model 210, the scorer model 220, and the ranker model 230. As discussed above, the inventory predictor model 210 receives the product identifier 22 associated with a product 24 and predicts, as an output, the mixture probability distribution 214 over possible quantities 212 for the product 24 associated with the product identifier 22. The mixture probability distribution 214 may include a probability of one or more of zero inventory, a correct inventory (e.g., the mixture probability distribution 214 matches the actual inventory of the product), or a long tail distribution. The long tail distribution may include one of a gamma distribution or a t-distribution.

The scorer model 220 is configured to receive the mixture probability distribution 214 over possible quantities 212 for each product 24 output by the inventory predictor model 210 and generate, using the mixture probability distribution 214, the inventory confidence score 222 for the product 24. Each inventory confidence score 222 indicates a confidence estimation of an actual inventory of the product. Put another way, each inventory confidence score 222 may identify a certainty in which the prediction output by the inventory predictor model 210 is approximately correct (i.e., close to an actual inventory of the product 24). For example, when the audit prioritizer 200 has a high degree of certainty that the predicted inventory of a particular product 24 is equal to or near the actual inventory of the product 24, the corresponding inventory confidence score 222 may be higher than the inventory confidence score 222 for a different product 24 where the audit prioritizer 200 has a lower degree of certainty that the predicted inventory of the different product 24 is equal to or near the actual inventory of the different product 24. The scorer model 220 may determine the inventory confidence score 222 based on one or more characteristics of the mixture probability distribution 214 (e.g., a density, a range, a standard deviation, etc.). For example, when the mixture probability distribution 214 of a first product 24 has a similar density across a large number of potential inventory values, the inventory confidence score 222 may be relatively lower than the inventory confidence score 222 of a second product 24 with a mixture probability distribution 214 that has a similar density over a smaller number of potential inventory values.

The ranker model 230 is configured to receive the plurality of inventory confidence scores 222 output by the scorer model 220 and select, using the plurality of inventory confidence scores 222, the list of candidate products 24C from the plurality of products 24. In some examples, the scorer model 220 generates the list of candidate products 24C by selecting the products 24 having the N-lowest inventory confidence scores 222 among the plurality of inventory confidence scores 222 determined for the plurality of products 24. In other words, the ranker model 230 may select a threshold quantity of respective products 24 from the plurality of products 24 with the lowest (or alternatively, the highest) inventory confidence scores 222 and generates the list of candidate products 24C to include the products 24 that the audit prioritizer 200 has identified as having the lowest confidence in the actual inventory of the product 24. More specifically, the ranker model 230, in some implementations, generates the list of candidate products 24C by ordering the products 24 from the product 24 having the lowest inventory confidence score 222 to the product 24 having the highest inventory confidence score 222.

In additional examples, the list of candidate products 24C includes only products 24 having inventory confidence scores 222 that fail to exceed a maximum confidence threshold (i.e., have uncertainty greater than or lesser than a threshold amount of uncertainty). Here, the maximum confidence threshold may be configurable (e.g., by the user 12 or based on characteristics of the products 24 or the corresponding business) and be associated with a high certainty that the actual inventory of the product 24 is accurate. In this way, a product 24 that the ranker model 230 identifies as having an inventory confidence score 222 that is more than the maximum confidence threshold can be effectively filtered out of the list of candidate products 24C. Put another way, the ranker model 230 may, when generating the list of candidate products 24C from the plurality of products 24, discard any products 24 from the list of candidate products 24C when the inventory confidence score 222 of the product indicates a confidence estimation that exceeds the maximum confidence threshold. In some implementations, the ranker model 230 determines that a candidate product 24C includes an inventory confidence score 222 that fails to satisfy a minimum confidence threshold (i.e., the scorer model 220 identifies the model 210 as having a low confidence in the mixture probability distribution 214 prediction). In some examples, based on the ranker model 230 determining that the candidate product 24C includes an inventory confidence score 222 that fails to satisfy the minimum confidence threshold, the audit prioritizer 200 automatically triggers a restock event of the candidate product 24C, rather than including the candidate product 24C in the list of candidate products 24C.

In additional examples, the inventory confidence scores 222 are combined with additional contextual information 224 such as business considerations for the particular products 24 in inventory. Here, the ranker model 230 may rank the list of candidate products 24C from the plurality of products based on the additional contextual information 224. For instance, the contextual information 224 includes a sales volume of each respective candidate product 24C, an audit history of each respective candidate product 24C, an inventory estimate of each respective candidate product 24C, and/or a product category of each respective candidate product 24C. For instance, products 24 with a higher sales volume may prioritized by appearing more frequently in audits to ensure the retailer maintains proper stock. The audit history may raise or lower a rank of a candidate product 24C in the ranked list of candidate products 24C based on how recently the candidate product 24C was audited (i.e., a recently audited product 24 may be more likely to have an accurate inventory and therefore be ranked lower in the re-ranking). The retailer may identify particular product categories to prioritize in audits, where the ranker model 230 ranks candidate products 24C based on the priority (e.g., a weight) of the product category that the candidate product 24C falls within. In essence, such contextual information 224 can be used to bias or weight the list of candidate products 24C to influence the priority that the candidate product 24C is positioned in the list of candidate products 24C that is tailored to the business needs of the retailer.

Additionally or alternatively, the list of candidate products 24C is considered jointly with the target product availability level of the retailer. In particular, each retailer may set a target product availability, and replenish inventory to meet the target product availability based on the variability of demand of each product 24. Here, the retailer may calculate inventory replenishments by jointly considering both the inventory confidence score 222 and the demand forecast for a given product 24.

With continued reference to FIG. 2, in this example, the inventory predictor model 210 receives the plurality of product identifiers 22a-c corresponding to the products 24a-c as input, and predicts, as output, the mixture probability distribution 214a-c over possible quantities 212a-c for each product 24. As shown, the mixture probability distribution 214a over possible quantities 212a of product 24a is relatively concentrated around the possible quantity 212a range of 2.3 to 3.5, indicating a moderate confidence estimation of the actual inventory of the product 24a. The mixture probability distribution 214b over possible quantities 212b of product 24b is concentrated around the possible quantity 212b range of 1.0 to 1.9, indicating, a high confidence estimation of the actual inventory of the product 24b. Whereas the mixture probability distribution 214c over possible quantities 212c of product 24c is widely distributed, indicating a low confidence estimation of the actual inventory of the product 24c.

The scorer model 220 receives each of the mixture probability distributions 214 over possible quantities 212 and generates, for each product 24, the inventory confidence score 222a-c indicating the confidence estimation of the actual inventory of the products 24a (i.e., moderate), 24b (i.e., high), 24c (i.e., low). Thereafter, the ranker model 230 receives the inventory confidence scores 222a-c and selects the list of candidate products 24C from the plurality of products 24. The list of candidate products 24C is based on the inventory confidence scores 222 received from the scorer model 220. Here, the ranker model 230 may discard a product 24 when the inventory confidence score 222 of the product exceeds a maximum confidence threshold. For example, as shown in FIG. 2, when generating the list of candidate products 24C, the ranker model 230 identifies the product 24b as having an inventory confidence score 222b indicating a high confidence estimation in the actual inventory of the product 24b and discards the product 24b from the list of candidate products 24C to prioritize in an inventory audit.

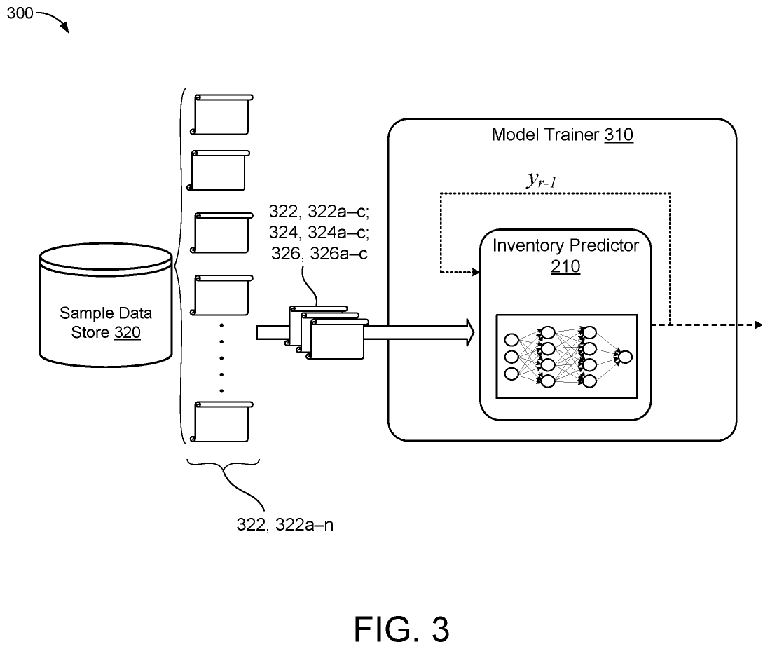

FIG. 3 shows an example of a training process 300 for training the inventory predictor model 210 to predict the mixture probability distribution 214 over possible quantities 212 for a product 24 in inventory. The training process 300 includes a model trainer 310 that obtains a plurality of historical training samples 322, 322a-n (also referred to herein as training samples 322) stored in a sample data store 320. The historical training samples 322 may include product features 324 (which may correspond with at least a portion of the contextual information 224 and/or the product features 25) paired with audit correction labels 326 as model targets. Here, the product features 324 may include one or more of an inventory history, a sales history, a replenishment history, an audit history, a product ID, a product category, a product description, an inventory store ID, a store type, or a store zip code. The audit correction labels 326 may correspond to previously recorded inventory adjustments for the product 24. Put another way, the audit correction labels 326 represent historical instances of the accuracy of the inventory record of the product 24 relative to the actual inventory of the product 24.

The model trainer 310 trains the model 210 using the historical training samples 322. The sample data store 130 may reside on the memory hardware 142 of the remote system 140. Training the model 210 using historical training samples 322 allows the model 210 to predict, based on product features 324 of the product 24, a mixture probability distribution 214 over possible inventory quantities 212 of the product 24. In the example shown in FIG. 3, the historical training samples 322a-c are sampled to train the model 210. The model 210 receives the historical training samples 322 as input and generates an output prediction yᵣ, which is tested for its accuracy. At each time-step during the training process 300, the inventory predictor model 210 is additionally trained using the output prediction for the previous time-step yᵣ₋₁.

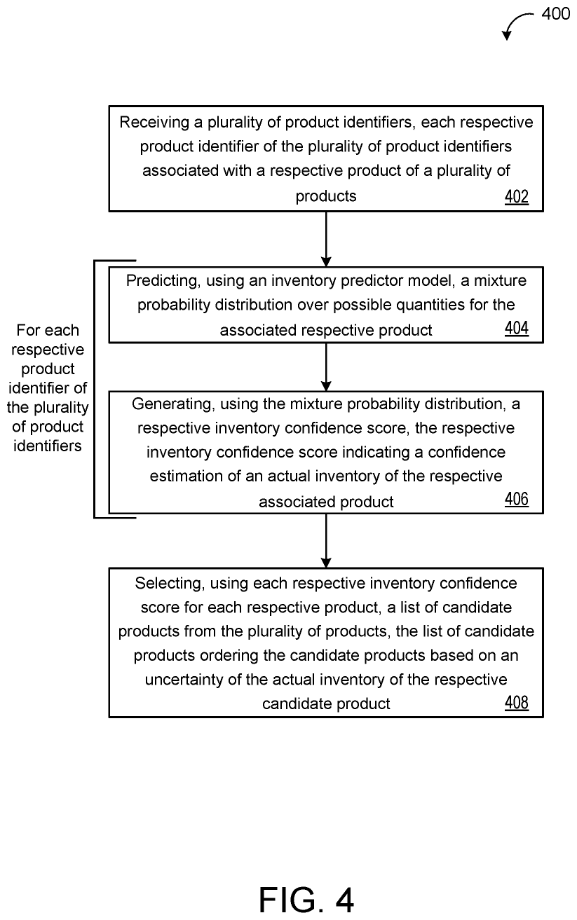

FIG. 4 is a flowchart of an exemplary arrangement of operations for a method 400 of prioritizing inventory checks and audits for a multi-product retailer. The method 400 includes, at operation 402, receiving a plurality of product identifiers 22. Each respective product identifier 22 of the plurality of product identifiers 22 is associated with a respective product 24 of a plurality of products 24.

For each respective product identifier 22 of the plurality of product identifiers 22, the method 400 also includes, at operation 404, predicting, using an inventory predictor model 210, a mixture probability distribution 214 over possible quantities 212 for the associated respective product 24. At operation 406, the method 400 also includes generating, using the mixture probability distribution 214, a respective inventory confidence score 222. Here, the respective inventory confidence score 222 indicates a confidence estimation of an actual inventory of the respective associated product 24. The method 400 further includes, at operation 408, selecting, using each respective inventory confidence score 222 for each respective product 24, a list of candidate products 24C from the plurality of products 24. Here, the list of candidate products 24C orders the candidate products 24C based on an uncertainty of the actual inventory of the respective candidate product 24C.

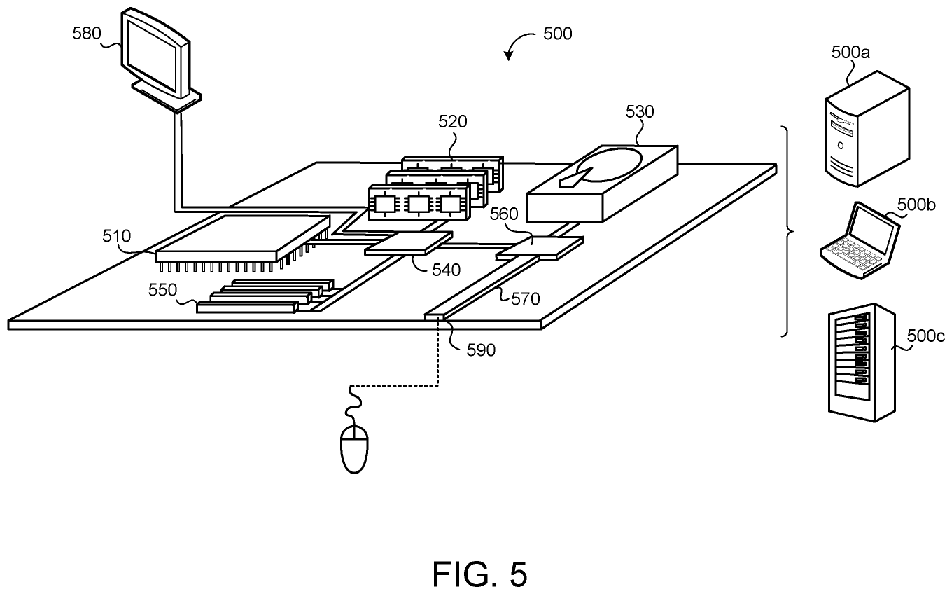

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 (e.g., the computing resources 18, 144 of FIG. 1) can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 (e.g., the storage resources 16, 142 of FIG. 1) stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
receiving a plurality of product identifiers, each respective product identifier of the plurality of product identifiers associated with a respective product of a plurality of products;
for each respective product identifier of the plurality of product identifiers:
predicting, using an inventory predictor model, a mixture probability distribution over possible quantities for the associated respective product; and
generating, using the mixture probability distribution, a respective inventory confidence score, the respective inventory confidence score indicating a confidence estimation of an actual inventory of the respective associated product; and
selecting, using each respective inventory confidence score for each respective product, a list of candidate products from the plurality of products, the list of candidate products ordering each respective candidate product based on an uncertainty of the actual inventory of the respective candidate product.

2. The method of claim 1, wherein the operations further comprise generating an audit notification comprising the list of candidate products.

3. The method of claim 1, wherein selecting the list of candidate products comprises selecting a threshold quantity of respective products from the plurality of products with the lowest inventory confidence score.

4. The method of claim 1, wherein the respective inventory confidence score of each respective candidate product of the list of candidate products satisfies a maximum confidence threshold.

5. The method of claim 1, wherein the operations further comprise:
determining that the respective inventory confidence score of a particular respective candidate product of the list of candidate products satisfies a minimum confidence threshold; and
in response to determining that the respective inventory confidence score of the particular respective candidate product of the list of candidate products satisfies the minimum confidence threshold, triggering a restock event of the particular respective candidate product.

6. The method of claim 1, wherein selecting the list of candidate products from the plurality of products comprises ordering each respective candidate product of the list of candidate products from the respective candidate product having the lowest inventory confidence score to the respective candidate product having the highest inventory confidence score.

7. The method of claim 1, wherein the mixture probability distribution over possible quantities for the respective product comprises a probability of one or more of:
zero inventory;
correct inventory; or
a long-tail distribution.

8. The method of claim 1, wherein the operations further comprise ranking the list of candidate products based on one or more of:
a sales volume of each respective candidate product;
an inventory estimate of each respective candidate product;
an audit history of each respective candidate product; or
a product category of each respective candidate product.

9. The method of claim 1, wherein the operations further comprise:
receiving training data comprising a plurality of product features paired with audit correction labels; and
training the inventory predictor model on the plurality of product features.

10. The method of claim 9, wherein the plurality of product features comprises one or more of:
an inventory history;
a sales history;
a replenishment history;
an audit history;
a product ID;
a product category;
a product description;
an inventory store ID;
a store type; or
a store zip code.

11. A system comprising:
data processing hardware; and
memory hardware storing instructions that when executed on the data processing hardware cause the data processing hardware to perform operations comprising:
receiving a plurality of product identifiers, each respective product identifier of the plurality of product identifiers associated with a respective product of a plurality of products;
for each respective product identifier of the plurality of product identifiers:
predicting, using an inventory predictor model, a mixture probability distribution over possible quantities for the associated respective product; and
generating, using the mixture probability distribution, a respective inventory confidence score, the respective inventory confidence score indicating a confidence estimation of an actual inventory of the respective associated product; and
selecting, using each respective inventory confidence score for each respective product, a list of candidate products from the plurality of products, the list of candidate products ordering each respective candidate product based on an uncertainty of the actual inventory of the respective candidate product.

12. The system of claim 11, wherein the operations further comprise generating an audit notification comprising the list of candidate products.

13. The system of claim 11, wherein selecting the list of candidate products comprises selecting a threshold quantity of respective products from the plurality of products with the lowest inventory confidence score.

14. The system of claim 11, wherein the respective inventory confidence score of each respective candidate product of the list of candidate products satisfies a maximum confidence threshold.

15. The system of claim 11, wherein the operations further comprise:
determining that the respective inventory confidence score of a particular respective candidate product of the list of candidate products satisfies a minimum confidence threshold; and
in response to determining that the respective inventory confidence score of the particular respective candidate product of the list of candidate products satisfies the minimum confidence threshold, triggering a restock event of the particular respective candidate product.

16. The system of claim 11, wherein selecting the list of candidate products from the plurality of products comprises ordering each respective candidate product of the list of candidate products from the respective candidate product having the lowest inventory confidence score to the respective candidate product having the highest inventory confidence score.

17. The system of claim 11, wherein the mixture probability distribution over possible quantities for the respective product comprises a probability of one or more of:
zero inventory;
correct inventory; or
a long-tail distribution.

18. The system of claim 11, wherein the operations further comprise ranking the list of candidate products from the plurality of products based on or more of:
a sales volume of each respective candidate product;
an inventory estimate of each respective candidate product;
an audit history of each respective candidate product; or
a product category of each respective candidate product.

19. The system of claim 11, wherein the operations further comprise:
receiving training data comprising a plurality of product features paired with audit correction labels; and
training the inventory predictor model on the plurality of product features.

20. The system of claim 19, wherein the plurality of product features comprises one or more of:
an inventory history;
a sales history;
a replenishment history;
an audit history;
a product ID;
a product category;
a product description;
an inventory store ID;
a store type; or
a store zip code.
